(19) United States
(12) Patent Application Publication
(10) Pub. No.: US 2008/0232354 A1
(43) Pub. Date: Sep. 25, 2008

(54) IP TELEPHONE SYSTEM, IP EXCHANGE, IP TERMINAL, IP EXCHANGE BACKUP METHOD, AND LOGIN METHOD FOR IP TERMINAL

(75) Inventors: Yuichi Tamakawa, Fukushima (JP); Takahiro Sasaki, Fukushima (JP); Hiroyuki Sato, Fukushima (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Communication Technologies Ltd.

(21) Appl. No.: 12/045,202

(22) Filed: Mar. 10, 2008

(30) Foreign Application Priority Data
Mar. 20, 2007 (JP) 2007-073507

(51) Int. Cl. H04L 12/66

(52) U.S. Cl. 370/352

(57) ABSTRACT

The present invention provides a technique suitable for the case where three or more IP exchanges are multiplexed each other. Priorities are respectively given to a plurality of IP exchanges 1. Each IP exchange 1 autonomously changes its operating mode such that the IP exchange having the highest priority among operating IP exchange 1 operates in a operation system and the other IP exchange 1 operates in a standby system. Further, an IP terminal 2 logins to the IP exchange 1 having the highest priority among the operating IP exchange 1, and receives the IP telephone service from the IP exchange 1.

### CLAIM OF PRIORITY

The present application claims priority from Japanese Patent Application P2007-73507 filed on Mar. 20, 2007, the content of which is hereby incorporated by reference into this application.

### BACKGROUND OF THE INVENTION

The present invention relates to an Internet Protocol (IP) telephone system having a plurality of IP exchanges and at least one IP terminal, and particularly to a redundancy technique for an IP telephone system.

Japanese Un-examined Patent Application Laid-Open No. 2006-254096 discloses an IP telephone system that backs up each base location to operate an IP terminal continuously even when a failure occurs in an IP exchange or a line so that, for example, an extension-to-extension call within a base location can be kept enabled.

In this system, when a failure occurs in an IP exchange or a line concerned, backup exchanges are switched from a standby system to an operation system and an IP terminal in each base location logs out from the IP exchange and logins to the backup exchange placed within own base location.

### SUMMARY OF THE INVENTION

In the above IP telephone system, IP exchanges are made redundant (duplex) by placing a backup IP exchange in each base location for backing up an IP exchange. However, this does not consider the case where three or more IP exchanges are multiplexed each other.

The present invention has been made considering the above situation. And, an object of the present invention is to provide a technique suitable for the case where three or more IP exchanges are multiplexed.

To solve the above problem, priorities are respectively given to a plurality of IP exchanges. Each IP exchange switches its operating mode autonomously such that the IP exchange having the highest priority operates in an operation system and the other IP exchange operates in a standby system. Further, an IP terminal logins to the IP exchange having the highest priority among the operating IP exchanges, to receive the IP telephone service from that IP exchange.

For example, the present invention provides an IP telephone system comprising: a plurality of IP exchanges connected with one another through an IP network, each of which operates in an operation system or a standby system; and at least one IP terminal that logins to one of the IP exchanges to receive an IP telephone exchange service from that IP exchange, wherein:

each of the plurality of IP exchanges comprises:

an operating mode notifying means, which notifies an operating mode of the IP exchange to other IP exchange;

an operation state judgment means, which judges an operation state of the other IP exchange on a basis of sending or non-sending of an operating mode notice from the other IP exchange;

an operation system switching means, which switches the operating mode of the IP exchange from the standby system to the operation system when the operating mode of the IP exchange is the standby system in a case where none of the other IP exchanges is judged to be operating in the operation system by the operation state judgment means and priorities of the plurality of the IP exchanges judged to be operating in the standby system by the operation state judgment means are lower than a priority of the IP exchange; and

a standby system switching means, which switches the operating mode of the IP exchange from the operation system to the standby system when the operating mode of the IP exchange is the operation system in a case where there is an IP exchange having a priority higher than the priority of the IP exchange among the other IP exchange judged to be operating in the standby system by the operation state judgment means.

Here, the above IP exchange may further comprise an inquiry response means, which respond to an operation state inquiry sent from the IP terminal.

Further, the above IP terminal may comprise:

a login destination candidate storage means, which stores an address information of each of the other IP exchange as candidates for a login destination, together with the priority given to the other IP exchange;

an inquiry sending means, which sends an operation state inquiry to a login destination candidate having a priority higher than the priority of the IP exchange to which the IP terminal has logged in; and

a login means, which logs out from the IP exchange to which the IP terminal has logged in and logins to the other IP exchange having a highest priority among the login destination candidate that has sent response to the operation state inquiry, when the response is received; and logs out from the IP exchange to which the IP terminal has logged in and logins to the other IP exchange whose information is stored in the login destination candidate storage means and has a priority one rank lower than the priority of the IP exchange from which the log-out is carried out, when a failure occurs in the other IP exchange to which the IP terminal has logged in.

According to the present invention, it is possible to switch respective operating modes of IP exchanges suitably even when three or more IP exchanges are multiplexed each other. Further, the login destination of an IP terminal can be changed to follow switching of the operating modes of the IP exchanges. Thus, it is possible to provide a technique suitable for the case where three or more IP exchanges are multiplexed each other.

### BRIEF DESCRIPTION OF THE DRAWINGS

FIG. 1 is a schematic diagram showing an IP telephone system to which one embodiment of the present invention is applied;

FIG. 2 is a schematic block diagram showing an IP exchange 1;

FIG. 3 is a schematic diagram showing a registration content of a managed object storage part 122

FIG. 4 is a flowchart for explaining operating mode switching processing performed by an IP exchange 1;

FIG. 5 is a flowchart for explaining the switching control processing (S112) shown in FIG. 4;

FIG. 6 is a schematic block diagram showing an IP terminal 2;

FIG. 7 is a schematic diagram showing a registration content of a login destination candidate storage part 251;

FIG. 8 is a flowchart for explaining login destination change processing performed by an IP terminal 2;

FIG. 9 is a flowchart for explaining the login control processing (S210) shown in FIG. 8;

FIG. 10 is a schematic diagram showing an example where the IP telephone system shown in FIG. 1 is applied to a relatively small business entity;

FIG. 11 is a sequence diagram for the example shown in FIG. 10 in the case where a failure occurs in an IP exchange 1 of an exchange ID “001” and accordingly the login destination of an IP terminal 2 is changed from the IP exchange 1 of the exchange ID “001” to an IP exchange 1 of the exchange ID “002”;

FIG. 12 is a sequence diagram for the example shown in FIG. 10 in the case where the IP exchange 1 of the exchange ID “001” is released from the failure and, as a result, the login destination of the IP terminal 2 is changed from the IP exchange 1 of the exchange ID “002” to the IP exchange 1 of the exchange ID “001”;

FIG. 13 is a schematic diagram showing an example where the IP telephone system shown in FIG. 1 is applied to a relatively large business entity;

FIG. 14 is a sequence diagram for the example shown in FIG. 13 in the case where a failure occurs in an IP exchange 1 of an exchange ID “001” and, as a result, the login destination of an IP terminal 2 placed in a branch office is changed from the IP exchange 1 of the exchange ID “001” to an IP exchange 1 of the exchange ID “002”;

FIG. 15 is a sequence diagram for the example shown in FIG. 13 in the case where a failure occurs in the IP exchange 1 of the exchange ID “002” while the IP exchange 1 of the exchange ID “001” is under suspension, and as a result the login destination of the IP terminal 2 located in the branch office is changed from the IP exchange 1 of the exchange ID “002” to an IP exchange 1 of the exchange ID “004” inside the branch office; and

FIG. 16 is a sequence diagram for the example shown in FIG. 13 in the case where the IP exchange 1 of the exchange ID “001” and the IP exchange 1 of the exchange ID “002” are released from the failures and, as a result, the login destination of the IP terminal 2 located in the branch office is changed from the IP exchange 1 of the exchange ID “004” to the IP exchange 1 of the exchange ID “001”.

### DESCRIPTION OF THE PREFERRED EMBODIMENTS

Hereinafter, embodiments of the present invention will be described.

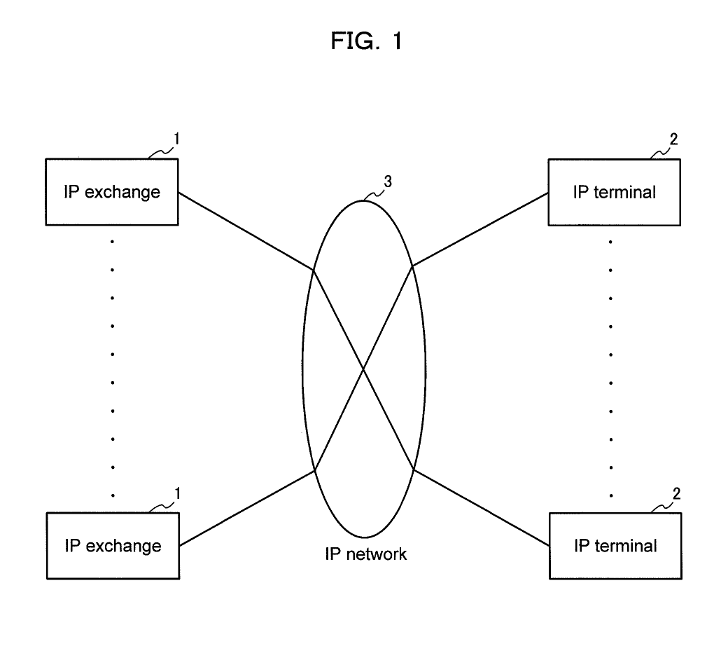

FIG. 1 is a schematic diagram showing an IP telephone system to which one embodiment of the present invention is applied.

As shown in the figure, the IP telephone system of the present embodiment comprises: a plurality of IP exchanges 1 connected to one another through an IP network 3; and at least one IP terminal 2. The IP exchanges 1 are assigned respective priorities.

Each IP exchange 1 autonomously switches its operating mode such that the IP exchange 1 having the highest priority among the operating IP exchanges 1 operates in an operation system while the other IP exchanges 1 operate in a standby system. Further, an IP terminal 2 loin to the IP exchange 1 having the highest priority among the operating IP exchanges 1, to receive IP telephone exchange service from that IP exchange 1.

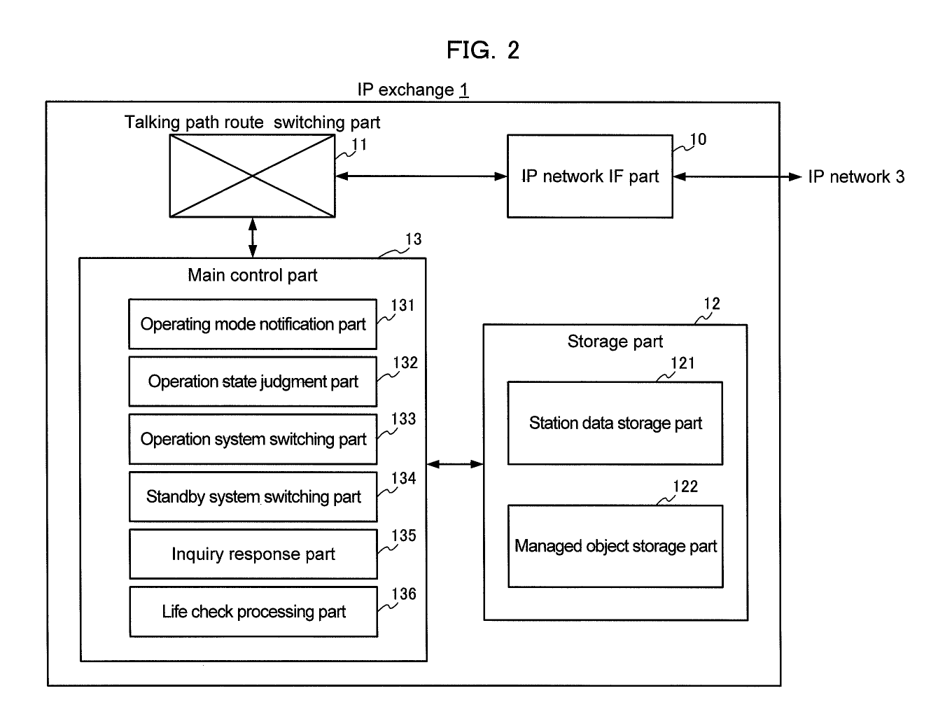

FIG. 2 is a schematic block diagram showing an IP exchange 1.

As shown in the figure, an IP exchange 1 comprises an IP network IF part 10, a talking path route switching part 11, a storage part 12 and a main control part 13.

The IP network IF part 10 is an interface for connecting to the IP network 3.

Under the control of the main control part 13, the talking path route switching part 11 provides the IP telephone exchange service to an IP terminal 2 that has logged in to this IP exchange 1 through the IP network IF part 10.

The storage part 12 stores information required for processes performed by the main control part 13. As shown in the figure, the storage part 12 comprises a station data storage part 121 and a managed object storage part 122.

The station data storage part 121 stores station data. The station data include a telephone number, an IP address and login information of each IP terminal 2 that can receive the IP telephone exchange service provided by this IP exchange 1.

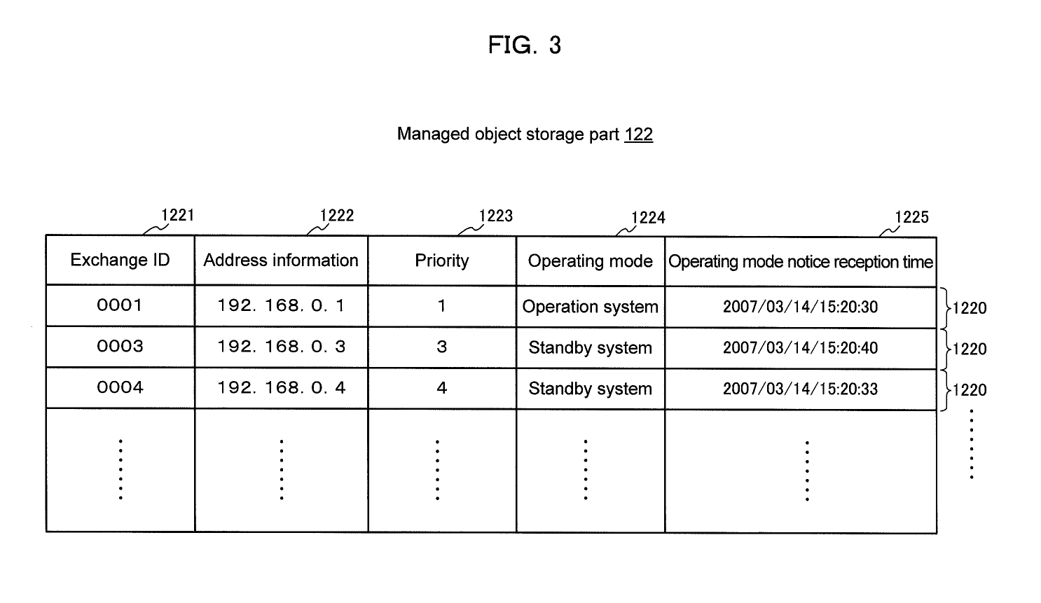

The managed object storage part 122 stores information on IP exchanges 1 whose operation states are managed among the IP exchanges 1 other than the IP exchange 1 to which this managed object storage part 122 belongs. FIG. 3 is a schematic diagram showing a registration content of the managed object storage part 122.

As shown in the figure, the managed object storage part 122 registers a record 1220 for each IP exchange 1 (hereinafter, referred to as a managed IP exchange). Each record 1220 has: a field 1221 for registering an exchange ID, i.e. identification information of the IP exchange 1 concerned; a field 1222 for registering address information of the IP exchange 1; a field 1223 for registering the priority given to the IP exchange 1; a field 1224 for registering the operating mode (operation system, standby system, or under suspension) of the IP exchange 1; and a field 1225 for registering the newest reception time of an operating mode notice received from the IP exchange 1.

Returning to FIG. 2, description will be continued.

The main control part 13 controls the parts 10-12 of its own IP exchange 1 in an integrated manner. For example, the main control part 13 receives a login request from an IP terminal 2 through the IP network IF part 10 and the talking path route switching part 11, and processes the login request by using the station data stored in the station data storage part 121 (login processing).

Further, the main control part 13 cooperates with the IP network IF part 10 and the talking path route switching part 11 to provide the IP telephone exchange service to an IP terminal 2 that has logged in to this IP exchange 1 (IP telephone exchange service processing).

Further, as shown in the figure, the main control part 13 comprises: an operating mode notification part 131, an operation state judgment part 132, an operation system switching part 133, a standby system switching part 134, an inquiry response part 135, and a life check processing part 136. The main control part 13 uses these parts 131-136 to switch the operating mode of its own IP exchange 1 into either the operation system or the standby system (operating mode switching processing). By the way, the above-mentioned login processing and IP telephone exchange service processing are performed when the operating mode of the IP exchange 1 concerned is the operation system, while they are not performed when the operating mode is the standby system.

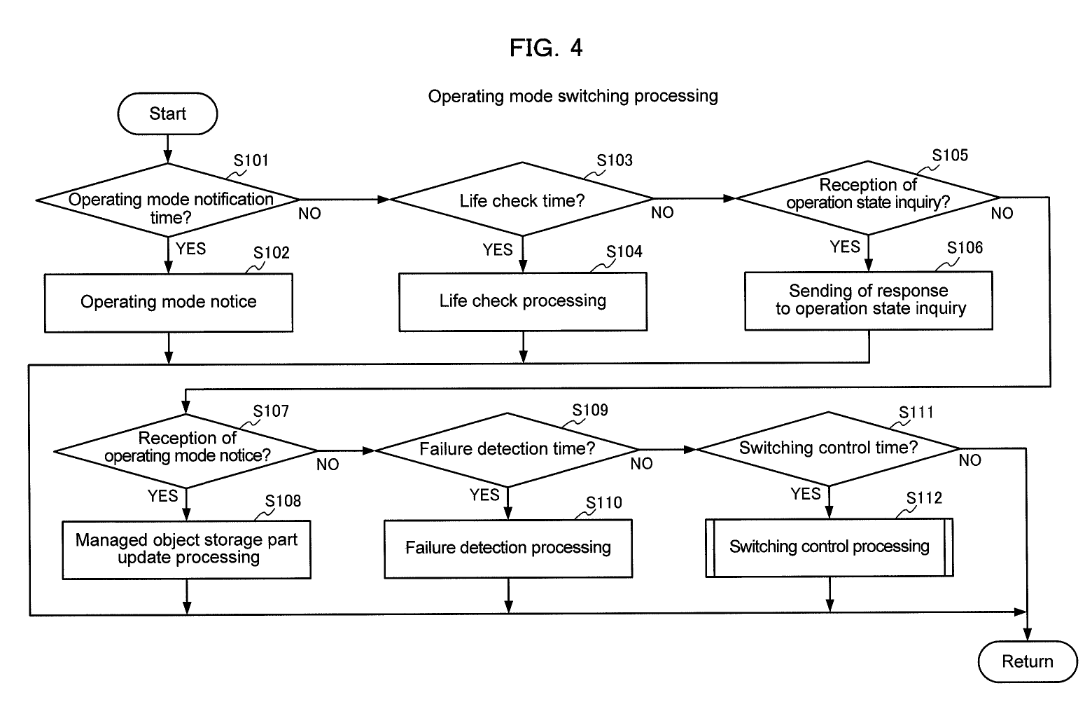

FIG. 4 is a flowchart for explaining the operating mode switching processing performed by an IP exchange 1.

When it is an operating mode notification time (which comes for example at predetermined intervals) (S101: YES), the operating mode notification part 131 generates an operating mode notice that includes the present mode of its own IP exchange 1. Then, the operating mode notification part 131 sends the operating mode notice to each of the managed IP exchanges 1 whose address information is stored in the managed object storage part 122, through the talking path route switching part 11 and the IP network IF part 10 (S102).

When it is a life check time (which comes for example at predetermined intervals) (S103: YES), then the life check processing part 136 performs life check processing with respect to each IP terminal 2 that has logged in (S104). In detail, the life check processing part 136 sends a life check notice to each IP terminal 2 that has logged in, through the talking path route switching part 11 and the IP network IF part 10, and awaits a response to the life check notice until a predetermined time-out period has elapsed. Then, the life check processing part 136 performs log-out processing with respect to each IP terminal 2 that has not sent a response to the life check notice during the predetermined time-out period.

When the inquiry response part 135 receives an operation state inquiry from an IP terminal 2 through the IP network IF part 10 and the talking path route switching part 11 (S105: YES), then the inquiry response part 135 returns a response to the inquiry to the IP terminal 2 (S106).

When the operation state judgment part 132 receives an operating mode notice from another IP exchange 1 through the IP network IF part 10 and the talking path route switching part 11 (S107: YES), then the operation state judgment part 132 performs processing of updating the managed object storage part 122 (S108). In detail, the operation state judgment part 132 searches the managed object storage part 122 for a record 1220 by using, as a key, the exchange ID or address information of the IP exchange 1 as the sender of the operating mode notice. Then, the operation state judgment part 132 updates the operating mode registered in the field 1224 of the retrieved record 1220 into the operating mode described in the operating mode notice. Further, the operation state judgment part 132 updates the operating mode notice reception time registered in the field 1225 of the record 1220 into the present time.

When it is a failure detection time (which comes for example at predetermined intervals) (S109: YES), the operation state judgment part 132 detects an IP exchange 1 under suspension owing to a failure or the like among the managed IP exchanges 1 (S110). In detail, the operation state judgment part 132 compares the operating mode notice reception time registered in the field 1225 with the present time for each record 1220 stored in the managed object storage part 122, to judge whether the record 1220 in question was updated during a predetermined period past. In the case where the record 1220 was not updated during the predetermined period, the operation state judgment part 132 judges that the IP exchange 1 corresponding to this record 1220 is under suspension owing to a failure or the like, and updates the operating mode registered in the field 1224 of this record 1220 into “under suspension”.

When it is a switching control time (which comes for example at predetermined intervals) (S111: YES), the operation state judgment part 132 performs switching control processing described in the following (S112).

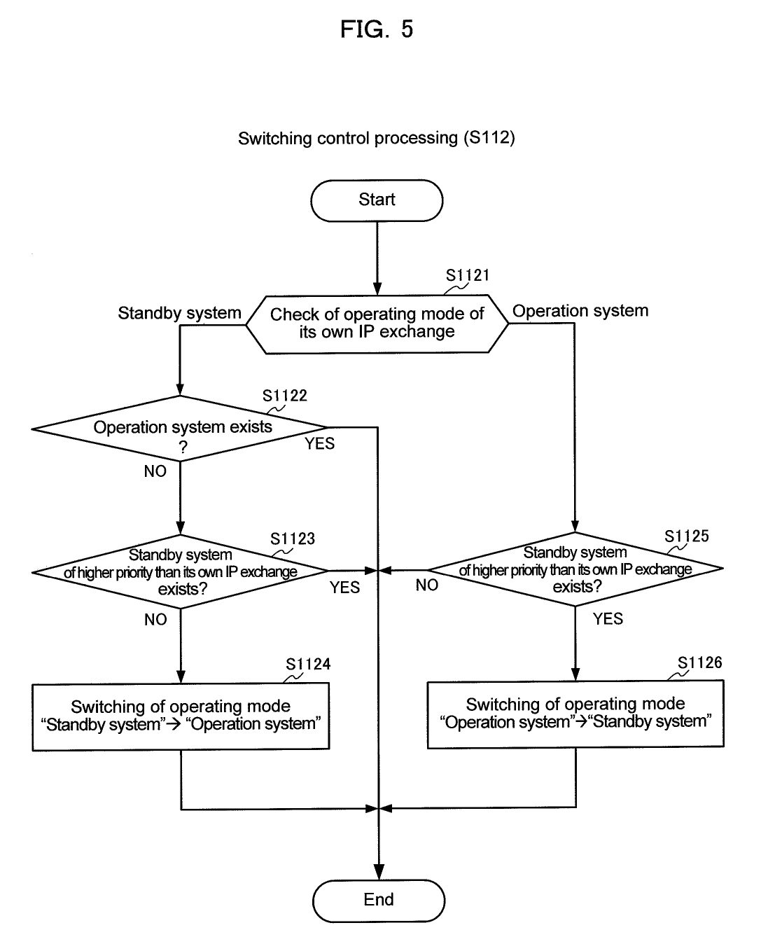

FIG. 5 is a flowchart for explaining the switching control processing (S112) shown in FIG. 4.

First, the main control part 13 checks the operating mode of its own IP exchange 1 (S1121). When the operating mode of its own IP exchange 1 is “standby system”, the flow proceeds to S1122. On the other hand, when the operating mode is “operation system”, the flow proceeds to S1125.

In S1122, the operation system switching part 133 refers to the managed object storage part 122 and examines whether an IP exchange 1 of the operating mode “operation system” exists among the managed IP exchanges 1. When an IP exchange 1 of the operating mode “operation system” exists (S1122: YES), then the flow is ended.

On the other hand, when no IP exchange 1 of the operating mode “operation system” exists (S1122: NO), then the operation system switching part 133 further examines whether there is an IP exchange 1 having the operating mode “standby system” and the priority higher than the priority of its own IP exchange 1 among the managed IP exchanges (S1123). When there is an IP exchange 1 having the operating mode “standby system” and the priority higher than the priority of its own IP exchange 1 (S1123: YES), then the flow is ended.

On the other hand, when there is no IP exchange 1 having the operating mode “standby system” and the priority higher than the priority of its own IP exchange 1 (S1123: NO), then the operation system switching part 133 switches the operating mode of its own IP exchange 1 from “standby system” to “operation system” (S1124). Thereafter, the flow is ended.

In S1125, the standby system switching part 134 examines whether there is an IP exchange 1 having the operating mode “standby system” and the priority higher than the priority given to its own IP exchange 1 among the managed IP exchanges 1. When there is no IP exchange 1 having the operating mode “standby system” and the priority higher than the priority given to its own IP exchange 1 (S1125: NO), then the flow is ended.

On the other hand, when there is an IP exchange 1 having the operating mode “standby system” and the priority higher than the priority given to its own IP exchange 1 (S1125: YES), then the standby system switching part 134 switches the operating mode of its own IP exchange 1 from “operation system” to “standby system” (S1126). Thereafter, the flow is ended.

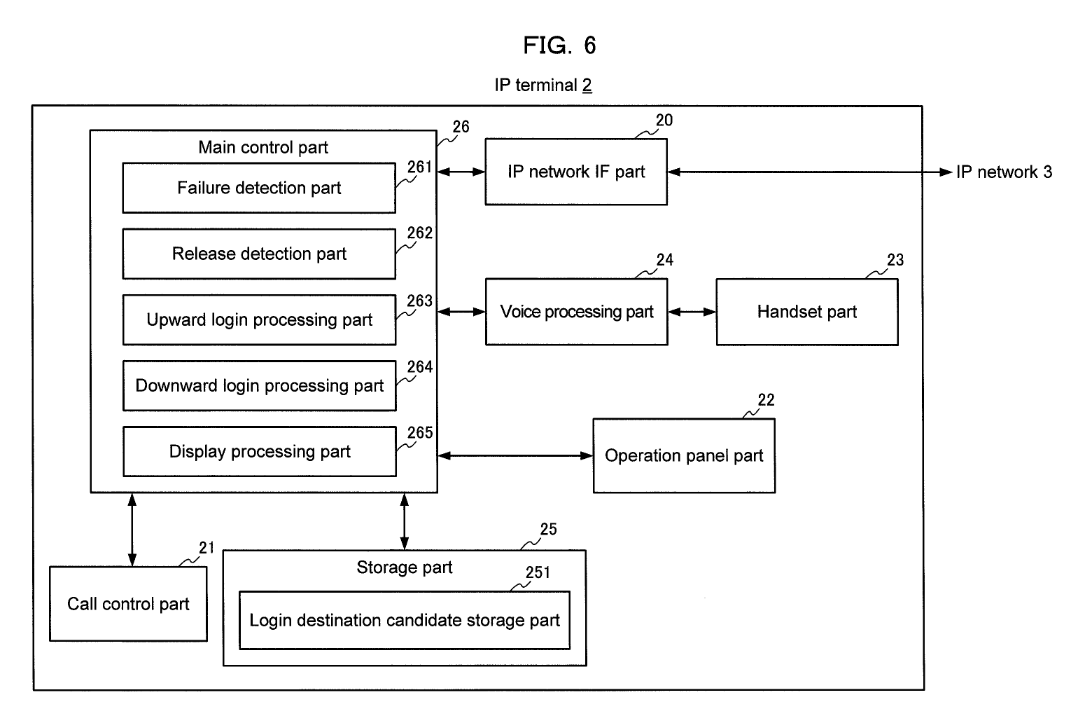

Next, an IP terminal 2 will be described. FIG. 6 is a schematic block diagram showing an IP terminal 2.

As shown in the figure, an IP terminal 2 comprises: an IP network IF part 20; a call control part 21; an operation panel part 22 provided with input keys such as dial keys and function keys and a display part such as an LCD; a handset part 23 provided with a microphone and a speaker; a voice processing part 24; a storage part 25; and a main control part 26.

The IP network IF part 20 is an interface for connecting with the IP network 3.

The call control part 21 performs call control processing according to a call control protocol such as SIP.

The voice processing part 24 processes voice packets received from the main control part 26, and outputs voice from the handset part 23. Further, the voice processing part 24 processes voice inputted to the handset part 23, converts the voice into voice packets, and sends the voice packets to the main control part 26.

The storage part 25 stores information required for processing in the main control part 26. As shown in the figure, the storage part 25 has a login destination candidate storage part 251.

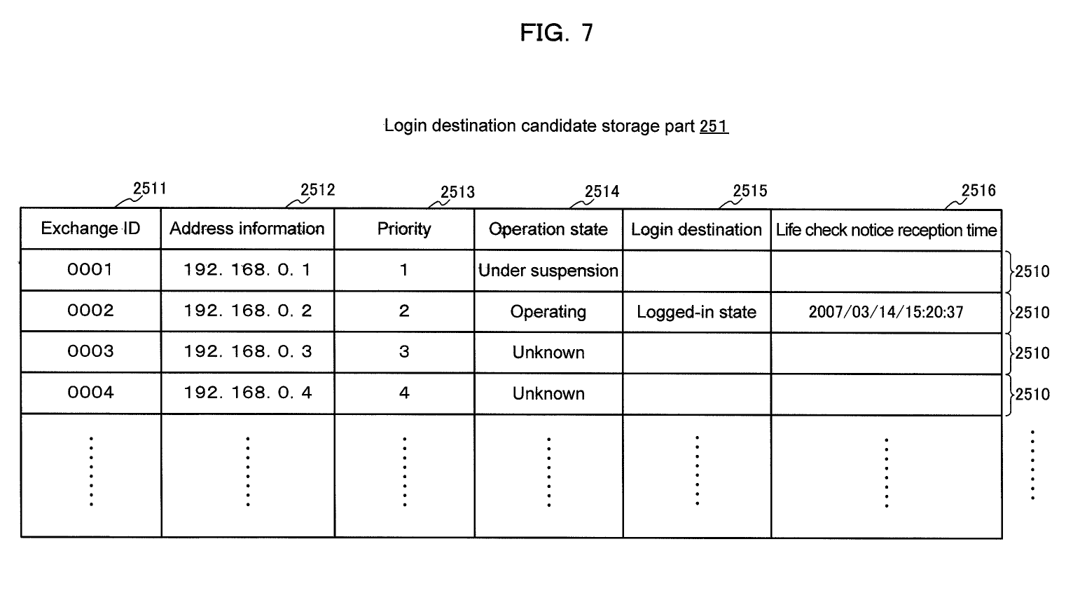

The login destination candidate storage part 251 stores information on IP exchanges 1 that can be candidates for a login destination of its own IP terminal 2. FIG. 7 is a schematic diagram showing a registration content of the login destination candidate storage part 251.

As shown in the figure, the login destination candidate storage part 251 registers a record 2510 for each IP exchange 1 as a login destination candidate. Each record 2510 has: a field 2511 for registering an exchange ID, i.e. identification information of the corresponding IP exchange 1; a field 2512 for registering address information of the corresponding IP exchange 1; a field 2513 for registering the priority given to the corresponding IP exchange 1; a field 2514 for registering an operation state (under suspension, operating, or unknown) of the corresponding IP exchange 1; a field 2515 for registering a flag that indicates whether the corresponding IP exchange 1 is the login destination IP exchange 1; and a field 2516 for registering the newest reception time of a life check notice received from the corresponding IP exchange 1 if that IP exchange 1 is the login destination IP exchange 1.

Returning to FIG. 6, description will be continued. The main control part 26 controls the parts 20-25 of its own IP terminal 2 in an integrated manner. In detail, when the main control part 26 receives a calling instruction accompanied with a accept number from an operator through the operation panel part 22, then the main control part 26 delivers the calling instruction to the call control part 21. Receiving the calling instruction, the call control part 21 performs outgoing calling processing directed to the IP exchange 1 to which the IP terminal 2 has logged in, in cooperation with the main control part 26, to establish a talking path rout with the intended party specified by the accept number.

Further, when the main control part 26 receives, through the IP network IF part 20, a call from the IP exchange 1 to which the IP terminal 2 has logged in, then the main control part 26 delivers the call to the call control part 21. Receiving this call, the call control part 21 performs incoming calling processing in cooperation with the main control part 26, to establish a talking path rout with the sender of the call.

Further, as shown in the figure, the main control part 26 comprises a failure detection part 261, a release detection part 262, an upward login processing part 263, a downward login processing part 264, and a display processing part 265. The main control part 26 uses these parts 261-265 to change a login destination IP exchange 1 in accordance with states of the login destination candidate IP exchanges 1 (login destination change processing).

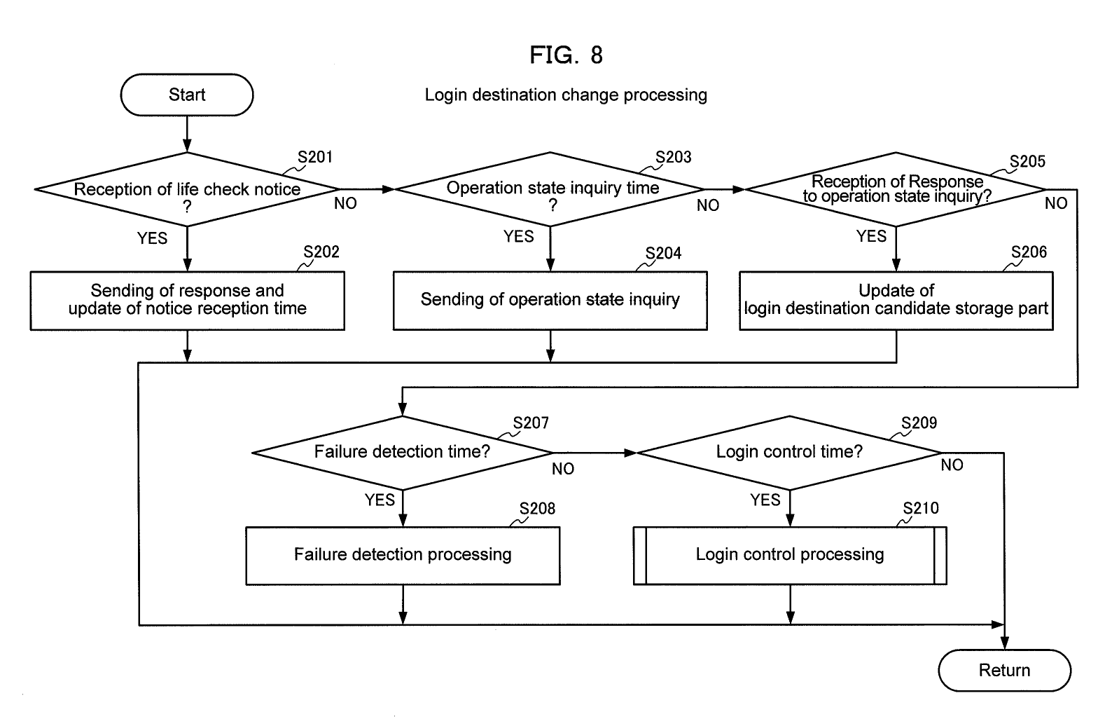

FIG. 8 is a flowchart for explaining the login destination change processing performed by an IP terminal 2.

When the failure detection part 261 receives a life check notice from the IP exchange 1 as the login destination through the IP network IF part 20 (S201: YES), then the failure detection part 261 returns a response to the life check notice. Further, failure detection part 261 searches the login destination candidate storage part 251 for the record 2510 of the login destination IP exchange 1 (i.e. the record 2510 of which the field 2512 registers the address of the sender of the life check notice and the field 2515 registers the flag indicating that the corresponding IP exchange 1 has been the login destination), and updates the life check notice reception time registered in the field 2516 of this record 2510 to the present time (S202).

Further, when it is an operation state inquiry time (which comes for example at predetermined intervals) (S203: YES), the release detection part 262 searches the login destination candidate storage part 251 for a record 2510 that has the priority higher than the priority of the login destination IP exchange 1. In the case where the release detection part 262 can retrieve a record 2510 of a login destination candidate having the priority higher than the priority of the login destination IP exchange 1, then the release detection part 262 sends a notice for inquiring about an operation state to the IP exchange 1 as the login destination candidate that is specified by the exchange ID registered in the field 2511 of the retrieved record 2510 or the address information registered in the field 2512 of the retrieved record 2510 (S204).

When the release detection part 262 receives a response to an operation state inquiry, from a login destination candidate IP exchange 1 through the IP network IF part 20 (S205: YES), then the release detection part 262 performs processing of updating the login destination candidate storage part 251 (S206). In detail, the release detection part 262 searches the login destination candidate storage part 251 for a record 2510 by using, as a key, the exchange ID or the address information of the IP exchange 1 as the sender of the response to the operation state inquiry. Then, the release detection part 262 updates the operation state registered in the field 2514 of the retrieved record 2510 into “operating”.

When it is a failure detection time (which comes for example at predetermine intervals) (S207: YES), the failure detection part 261 judges whether a failure has occurred in the IP exchange 1 as the login destination (S208). In detail, with respect to the record 2510 of the IP exchange 1 as the login destination, which is stored in the managed object storage part 122, the failure detection part 261 compares the life check notice reception time registered in the field 2516 with the present time, to judge whether a life check notice was received during a predetermined period past. In the case where a life check notice was not received during the predetermined period, the failure detection part 261 judges that a failure has occurred in the IP exchange 1 as the login destination, and updates the operation state registered in the field 2514 of the record 2510 into “under suspension”. Further, the display processing part 265 displays a message on the operation panel part 22 to the effect that a failure has occurred in the login destination IP exchange 1.

When it is a login control time (which comes for example at predetermined intervals) (S209: YES), the main control part 26 performs login control processing (S210) described in the following.

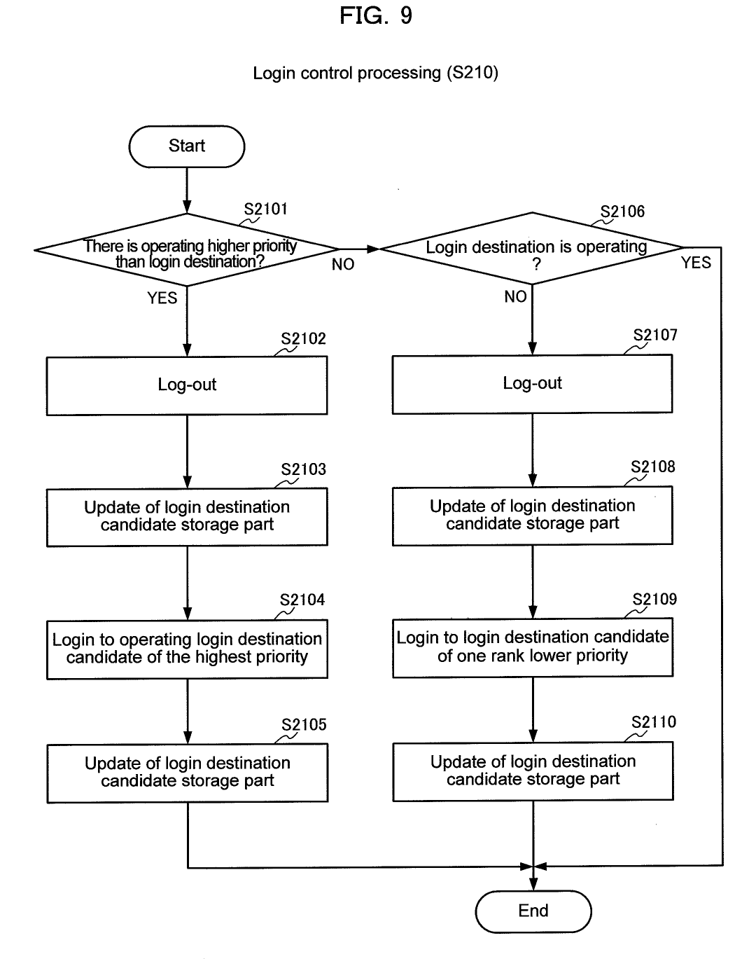

FIG. 9 is a flowchart for explaining the login control processing (S210) shown in FIG. 8.

First, the main control part 26 refers to the login destination candidate storage part 251 to examine whether there is an operating IP exchange 1 having the priority higher than the priority of the IP exchange 1 as the login destination (S2101). In detail, the main control part 26 searches the login destination candidate storage part 251 for a record 2510 whose field 2515 registers the flag indicating that the corresponding IP exchange has been the login destination. Next, the main control part 26 specifies the priority registered in the field 2513 of the retrieved record 2510. Then, the main control part 26 searches the login destination candidate storage part 251 for a record 2510 of which the field 2513 registers a priority higher than the specified priority and of which the field 2514 registers the operation state “operating”.

In the case where there is an operating IP exchange 1 having the priority higher than the priority of the IP exchange 1 as the login destination (S2101: YES), the upward login processing part 263 sends a log-out request to the IP exchange 1 to which the IP terminal 2 has logged in, through the IP network IF part 20, to log out from that IP exchange 1 (S2102).

Next, the upward login processing part 263 updates the record 2510 of the login destination IP exchange 1, which is stored in the login destination candidate storage part 251 (S2103). In detail, the upward login processing part 263 searches the login destination candidate storage part 251 for the record 2510 whose field 2515 registers the flag indicating that the corresponding IP exchange has been the login destination. Next, the upward login processing part 263 deletes the flag indicating that the corresponding IP exchange has been the login destination registered in the field 2515 of the retrieved record 2510 and the life check reception time registered in the field 2516 of the retrieved record 2510, and updates the operation state registered in the field 2514 of the retrieved record 2510 into “unknown”. Further, the display processing part 265 displays a message on the operation panel part 22 to the effect that the IP terminal 2 has logged out from the IP exchange 1 that has been so far the login destination.

Next, the upward login processing part 263 logins to an operating IP exchange 1 having the highest priority (S2104). In detail, the upward login processing part 263 searches the login destination candidate storage part 251 for a record 2510 having the highest priority registered in the field 2513 among the records 2510 whose fields 2514 register the operation state “operating”. Then, the upward login processing part 263 sends a login request to the IP exchange 1 that is specified by the exchange ID registered in the field 2511 of the retrieved record 2510 or the address information registered in the field 2512 of the retrieved record 2510, through the IP network IF part 20, to login that IP exchange 1.

Next, the upward login processing part 263 updates the record 2510 of the IP exchange 1 as the login destination, which is stored in the login destination candidate storage part 251 (S2105). In detail, the upward login processing part 263 searches the login destination candidate storage part 251 for a record 2510 of which the field 2511 registers the exchange ID of the IP exchange 1 as the login destination or of which the field 2512 registers the address information of the IP exchange 1 as the login destination. Next, the upward login processing part 263 registers the flag indicating that the corresponding IP exchange has been the login destination, in the field 2515 of the retrieved record 2510. Further, the display processing part 265 displays a message on the operation panel part 22 to the effect that login to the IP exchange 1 has been carried out.

On the other hand, in the case where there is no operating IP exchange 1 having the priority higher than the priority of the IP exchange 1 as the login destination (S2101: NO), the main control part 26 refers to the login destination candidate storage part 251 to examine whether the IP exchange 1 as the login destination is operating or not (S2106). In detail, the main control part 26 searches the login destination candidate storage part 251 for a record 2510 whose field 2515 registers the flag indicating that the corresponding IP exchange has been the login destination. Then, the main control part 26 examines whether the operation state registered in the field 2514 of the retrieved record 2510 is “operating”. In the case where the IP exchange 1 as the login destination is operating (S2106: YES), the flow is ended.

In the case where the IP exchange 1 as the login destination is not operating (S2106: NO), the downward login processing part 264 sends a log-out request to the IP exchange 1 that has been the login destination, through the IP network IF part 20, to log out from the IP exchange 1 (S2107).

Next, the downward login processing part 264 updates the record 2510 of the login destination IP exchange 1, which is stored in the login destination candidate storage part 251 (S2108). In detail, the downward login processing part 264 searches the login destination candidate storage part 251 for a record 2510 whose field 2515 registers the flag indicating that the corresponding IP exchange has been the login destination. Next, the downward login processing part 264 deletes the flag (which indicates that the corresponding IP exchange has been the login destination) registered in the field 2515 of the retrieved record 2510 and the life check reception time registered in the field 2516 of the retrieved record 2510, and updates the operation state registered in the field 2514 of the retrieved record 2510 into “unknown”. Further, the display processing part 265 displays a message on the operation panel part 22 to the effect that log-out from the IP exchange 1 so far has been the login part is carried out.

Next, the downward login processing part 264 logins to an IP exchange 1 that has the priority one rank lower than the priority of the IP exchange 1 from which log-out has been carried out (S2109). In detail, the downward login processing part 264 searches the login destination candidate storage part 251 for a record 2510 having the highest priority registered in the field 2513 among the records 2510 whose fields 2514 register the operation state “unknown” (except for the record 2510 of the IP exchange 1 from which log-out has been carried out just before). Then the downward login processing part 264 sends a login request, through the IP network IF part 20, to the IP exchange 1 specified by the exchange ID registered in the field 2511 of the retrieved record 2510 or the address information registered in the field 2512 of the retrieved record 2510, to login to that IP exchange 1. When the login to that IP exchange 1 ends in failure, the downward login processing part 264 logins to an IP exchange 1 that has the priority further one rank lower.

When the login is successful, the downward login processing part 264 updates the record 2510 of the IP exchange 1 as the login destination, which is stored in the login destination candidate storage part 251 (S2110). In detail, the downward login processing part 264 searches the login destination candidate storage part 251 for the record 2510 of which the field 2511 registers the exchange ID of the IP exchange 1 as the login destination or of which the field 2512 registers the address information of that IP exchange 1. Next, the downward login processing part 264 registers the flag indicating that the corresponding IP exchange has been the login destination in the field 2515 of the retrieved record 2510, and updates the operation state registered in the field 2514 of the retrieved record 2510 into “operating”. Further, the display processing part 265 displays a message on the operation panel part 22 to the effect that login to the IP exchange 1 has been carried out.

Next, an example of operation of the IP telephone system shown in FIG. 1 will be described.

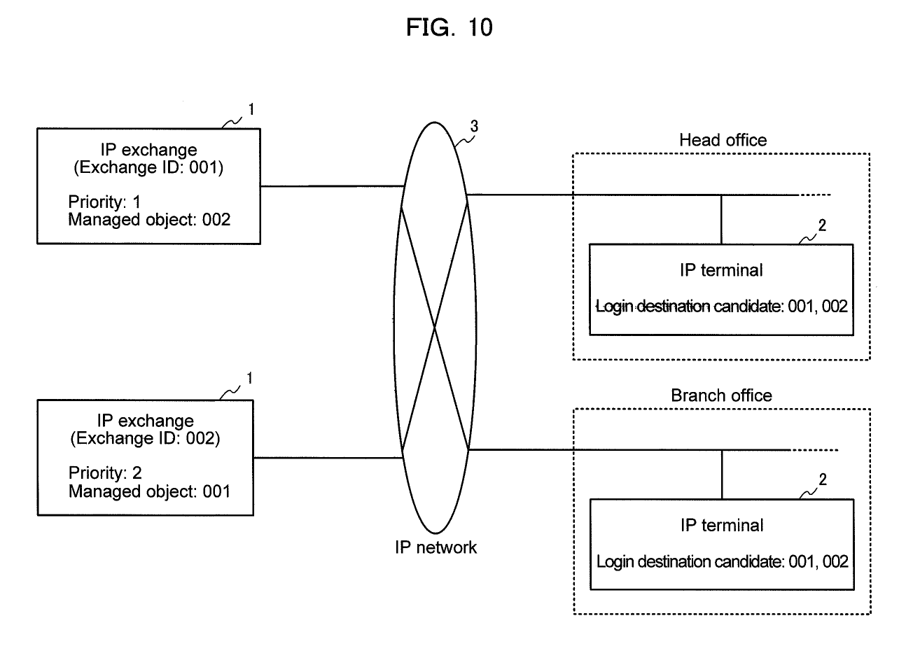

FIG. 10 shows an example where the IP telephone system shown in FIG. 1 is applied to a relatively small business entity. In this example, an IP terminal 2 is placed in each base location such as a head office and a branch office. Further, in this example, two IP exchanges 1 (having respective exchange IDs “001” and “002”) cover IP telephone exchange service for all these IP terminals 2.

As shown in the figure, the IP exchange 1 of the exchange ID “001” has the priority “1”, and the managed object storage part 122 of the IP exchange 1 registers information on the IP exchange 1 of the exchange ID “002” as information on the managed IP exchange 1.

Further, the IP exchange 1 of the exchange ID “002” has the priority “2”, and the managed object storage part 122 of the IP exchange 1 registers information on the IP exchange 1 of the exchange ID “001” as information on the managed IP exchange 1.

Further, the login destination candidate storage part 251 of each of the IP terminals 2 placed in the head and branch offices registers information on the IP exchanges 1 of the exchange IDs “001” and “002” as information on the IP exchanges 1 as login destination candidates.

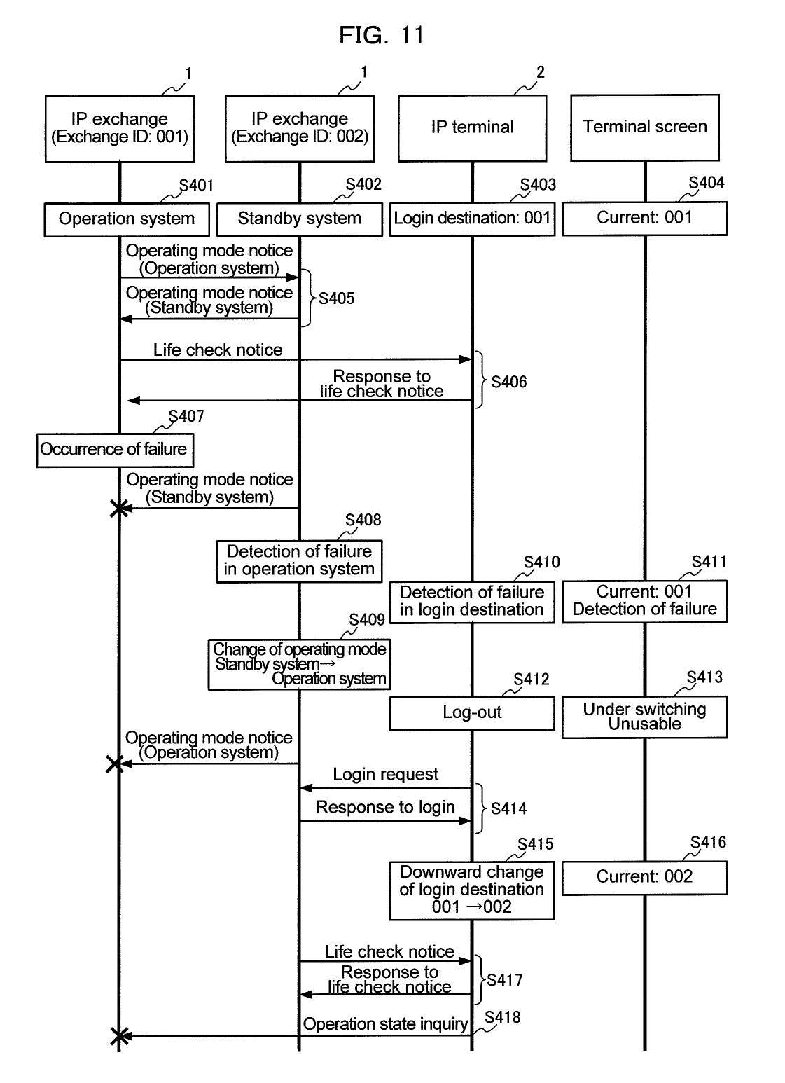

FIG. 11 is a sequence diagram showing the case where a failure occurs in the IP exchange 1 of the exchange ID “001” in the example shown in FIG. 10, and accordingly the login destination of the IP terminal 2 is changed from the IP exchange 1 of the exchange ID “001” to the IP exchange 1 of the exchange ID “002”.

It is assumed that the IP exchange 1 of the exchange ID “001” is operating in “operation system” (S401) and the IP exchange 1 of the exchange ID “002” in “standby system” (S402), and the login destination of the IP terminal 2 is the IP exchange 1 of the exchange ID “001” (S403).

In this case, the IP terminal 2 displays a message on terminal screen (the operation panel part 22) to indicate that it is has logged in to the IP exchange 1 of the exchange ID “001” (S404).

Further, the IP exchange 1 of the exchange ID “001” periodically sends an operating mode notice, which describes the operating mode “operation system” of the IP exchange 1 of the exchange ID “001”, to the IP exchange 1 of the exchange ID “002”. Similarly, the IP exchange 1 of the exchange ID “002” periodically sends an operating mode notice, which describes the operating mode “standby system” of the IP exchange 1 of the exchange ID “002”, to the IP exchange 1 of the exchange ID “001” (S405).

Further, the IP exchange 1 of the exchange ID “001” performs the life check processing on the IP terminal 2 that has logged in to the IP exchange 1 of the exchange ID “001”, by periodically sending a life check notice to the IP terminal 2 and by confirming a response to the life check notice from the IP terminal 2 (S406).

Now, it is assumed that a failure has occurred in the IP exchange 1 of the exchange ID “001” and the operation of the IP exchange 1 of the exchange ID “001” is suspended (S407). As a result, sending of an operating mode notice by the IP exchange 1 of the exchange ID “001” is suspended, and the IP exchange 1 of the exchange ID “002” detects the failure in the IP exchange 1 having the operating mode “operation system” (S408). Then, the IP exchange 1 of the exchange ID “002” changes the operating mode of the IP exchange 1 of the exchange ID “002” from “standby system” to “operation system” (S409).

Further, sending of a life check notice by the IP exchange 1 of the exchange ID “001” is suspended, and the IP terminal 2 the exchange ID “002” detects the failure in the IP exchange 1 as the login destination (S410). Then, the IP terminal 2 displays a message on the terminal screen to indicate that a failure has occurred in the IP exchange 1 as the login destination (S411).

Next, the IP terminal 2 logs out from the IP exchange 1 (of the exchange ID “001”) as the login destination (S412), and logins to the IP exchange 1 of the exchange ID “002” (S414). As a result, the login destination of this IP terminal 2 is changed from the IP exchange 1 of the exchange ID “001” to the IP exchange 1 of the exchange ID “002” (S415).

Here, between the log-out from the IP exchange 1 of the exchange ID “001” and the login to the IP exchange 1 of the exchange ID “002”, the IP terminal 2 displays a message on the terminal screen (the operation panel part 22) to the effect that the IP telephone exchange service can not be provided (S413). Then, when the IP terminal 2 logins to the IP exchange 1 of the exchange ID “002”, the IP terminal 2 displays a message on the terminal screen (the operation panel part 22) to indicate that it has logged in to the IP exchange 1 of the exchange ID “002” (S416).

Thereafter, the IP exchange 1 of the exchange ID “002” performs the life check processing on the IP terminal 2 that has logged in to the IP exchange 1 of the IP exchange 1 of the exchange ID “002”, by periodically sending a life check notice to the IP terminal 2 and by confirming a response from the IP terminal 2 to the life check notice (S417).

Further, the IP terminal 2 examines whether the IP exchange 1 of the exchange ID “001” is released, by periodically sending an operation state inquiry to the IP exchange 1 of the exchange ID “001” and by confirming a response to the operation state inquiry (S418).

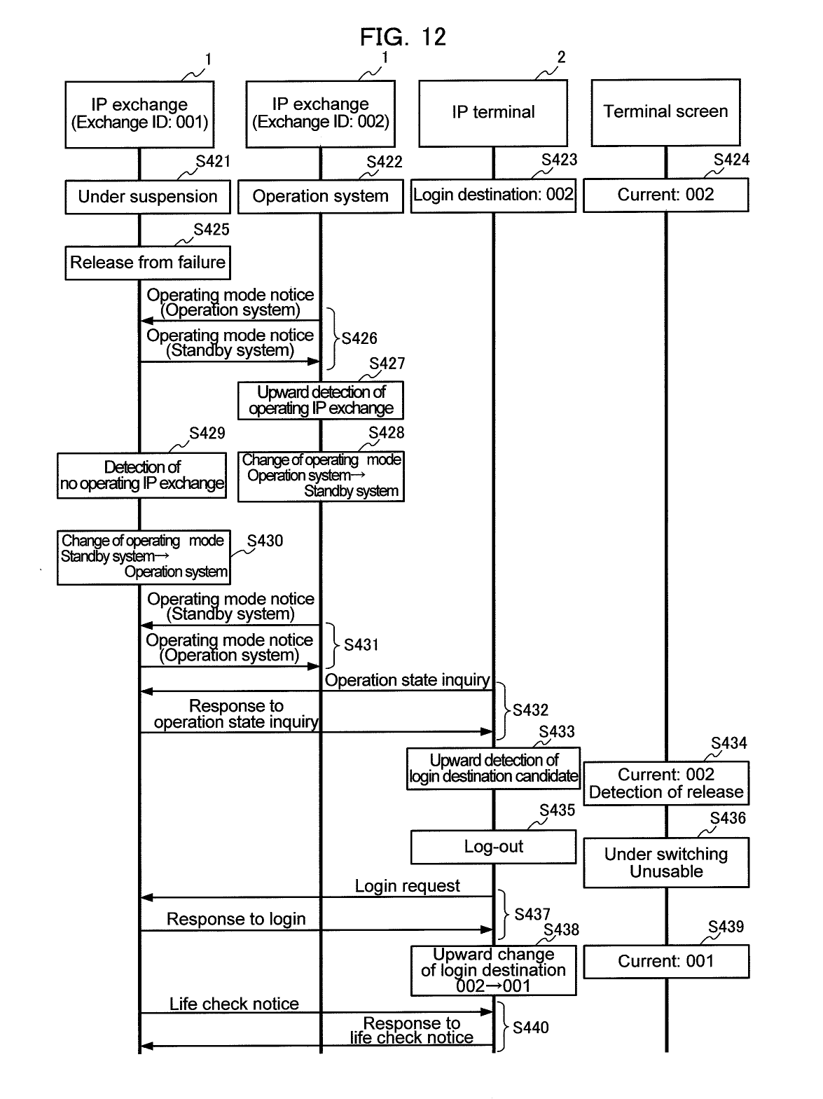

FIG. 12 is a sequence diagram showing the case where the IP exchange 1 of the exchange ID “001” in the example shown in FIG. 10 is released from a failure, and as a result the login destination of an IP terminal 2 is changed from the IP exchange 1 of the exchange ID “002” to the IP exchange 1 of the exchange ID “001”.

It is assumed that the IP exchange 1 of the exchange ID “001” is under suspension (S421), the IP exchange 1 of the exchange ID “002” is operating in “operation system” (S422), and the login destination of the IP terminal 2 is the IP exchange 1 of the exchange ID “002” (S423).

In this case, the IP terminal 2 displays a message on the terminal screen (the operation panel part 22) to indicate that the IP terminal 2 has logged in to the IP exchange 1 of the exchange ID “002” (S424).

Then, it is assumed that the IP exchange 1 of the exchange ID “001” is released from the failure and restarts the operation in “standby” (S425). The IP exchange 1 of the exchange ID “002” periodically sends an operating mode notice describing the operating mode “operation system” of the IP exchange 1 of the exchange ID “002” to the IP exchange 1 of the exchange ID “001”. In addition, the IP exchange 1 of the exchange ID “001” resumes periodical sending of an operating mode notice describing the operating mode “standby system” of the IP exchange 1 of the exchange ID “001” to the IP exchange 1 of the exchange ID “002” (S426).

As a result, the IP exchange 1 of the exchange ID “002” detects the operation of the IP exchange 1 of the exchange ID “001” that has the priority higher than the priority of the IP exchange 1 of the exchange ID “002” (S427). Then, the IP exchange 1 of the exchange ID “002” changes the operating mode of the IP exchange 1 of the exchange ID “002” from “operation system” to “standby system” (S428).

Thereafter, the IP exchange 1 of the exchange ID “001” detects that there is no IP exchange 1 operating in “operation system” (S429). Then, the IP exchange 1 of the exchange ID “001” confirms that the IP exchange 1 of the exchange ID “001” has the highest priority among the operating IP exchanges 1, and switches the operating mode the IP exchange 1 of the exchange ID “001” from “standby system” to “operation system” (S430).

As a result, the IP exchange 1 of the exchange ID “001” periodically sends an operating mode notice, which describes the operating mode “operation system” of the IP exchange 1 of the exchange ID “001”, to the IP exchange 1 of the exchange ID “002”. Similarly, the IP exchange 1 of the exchange ID “002” periodically sends an operating mode notice, which describes the operating mode “standby system” of the IP exchange 1 of the exchange ID “002”, to the IP exchange 1 of the exchange ID “001” (S431).

Further, the IP exchange 1 of the exchange ID “001” responds to an operation state inquiry that is periodically sent from the IP terminal 2 (S432). From this response, the IP terminal 2 detects that the IP exchange 1 of the exchange ID “001” as a login destination candidate having the priority higher than the priority of the IP exchange 1 as the login destination (having the exchange ID “002”) has been released (S433). Then, the IP terminal 2 displays a message on the terminal screen (the operation panel part 22) to indicate that the IP exchange 1 (having the exchange ID “001”) as a login destination candidate having the priority higher than the priority of the IP exchange 1 as the login destination (having the exchange ID “002”) has been released (S434).

Then, the IP terminal 2 logs out from the IP exchange 1 as the login destination (having the exchange ID “002”) (S435), and logins to the IP exchange 1 of the exchange ID “001” (S437). As a result, the login destination of the IP terminal 2 is changed from the IP exchange 1 of the exchange ID “002” to the IP exchange 1 of the exchange ID “001” (S438).

Here, between the log-out from the IP exchange 1 of the exchange ID “002” and the login to the IP exchange 1 of the exchange ID “001”, the IP terminal 2 displays a message on the terminal screen (the operation panel part 22) to the effect that the IP telephone exchange service can not be provided (S436). Then, when the IP terminal 2 logins to the IP exchange 1 of the exchange ID “001”, the IP terminal 2 displays a message on the terminal screen (the operation panel part 22) to indicate that it has logged in to the IP exchange 1 of the exchange ID “001” (S439).

Thereafter, the IP exchange 1 of the exchange ID “001” performs the life check processing on the IP terminal 2 that has logged in to the IP exchange 1 of the exchange ID “001”, by periodically sending a life check notice to the IP terminal 2 and by confirming a response from the IP terminal 2 to the life check notice (S440).

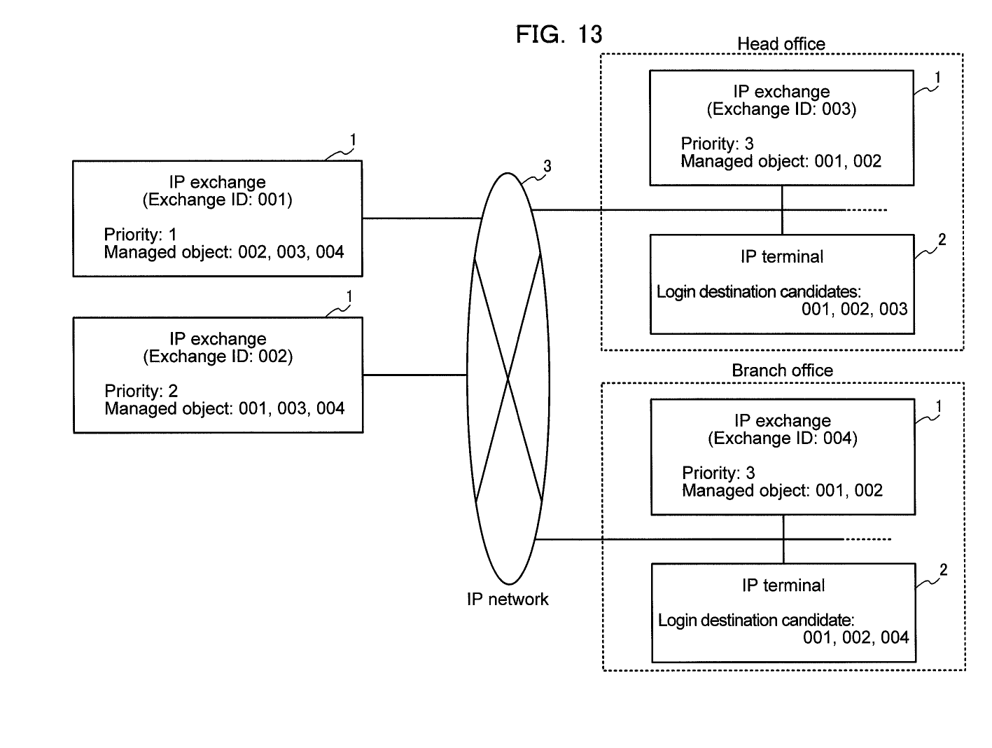

FIG. 13 shows an example where the IP telephone system shown in FIG. 1 is applied to a relatively large business entity. In this example, an IP terminal 2 is placed in each base location such as a head office and a branch office. And, two IP exchanges 1 (having respective exchange IDs “001” and “002”) cover IP telephone exchange service for all these IP terminals 2. Further, in this example, when failures occur in both of these two IP exchanges 1 (having the respective exchange IDs “001” and “002”) respectively, an IP exchange 1 of the exchange ID “003” covers the IP telephone exchange service for the IP terminal 2 placed in the head office, and an IP exchange 1 of the exchange ID “004” covers the IP telephone exchange service for the IP terminal 2 placed in the branch office.

As shown in the figure, the IP exchange 1 of the exchange ID “001” has the priority “1”. The managed object storage part 122 of the IP exchange 1 of the exchange ID “001” stores information on the IP exchange 1 of the exchange ID “002”, the IP exchange 1 of the exchange ID “003” and the IP exchange 1 of the exchange ID “004” as information on the managed IP exchanges 1.

Further, the IP exchange 1 of the exchange ID “002” has the priority “2”. The managed object storage part 122 of the IP exchange 1 of the exchange ID “002” stores information on the IP exchange 1 of the exchange ID “001”, the IP exchange 1 of the exchange ID “003” and the IP exchange 1 of the exchange ID “004” as information on the managed IP exchanges 1.

Further, the IP exchange 1 of the exchange ID “003” has the priority “3”. The managed object storage part 122 of the IP exchange 1 of the exchange ID “003” stores information on the IP exchange 1 of the exchange ID “001” and the IP exchange 1 of the exchange ID “002” as information on the managed IP exchanges 1.

Further, the IP exchange 1 of the exchange ID “004” has the priority “4”. The managed object storage part 122 of the IP exchange 1 of the exchange ID “004” stores the information on the IP exchange 1 of the exchange ID “001” and the IP exchange 1 of the exchange ID “002” as information on the managed IP exchanges 1.

Further, the login destination candidate storage part 251 of the IP terminal 2 placed in the head office stores the information on the IP exchange 1 of the exchange ID “001”, the information on the IP exchange 1 of the exchange ID “002” and the information on the IP exchange 1 of the exchange ID “003” as information on IP exchanges 1 as login destination candidates.

Further, the login destination candidate storage part 251 of the IP terminal 2 placed in the branch office stores the information on the IP exchange 1 of the exchange ID “001”, the information on the IP exchange 1 of the exchange ID “002” and the information on the IP exchange 1 of the exchange ID “004” as information on IP exchanges 1 as login destination candidates.

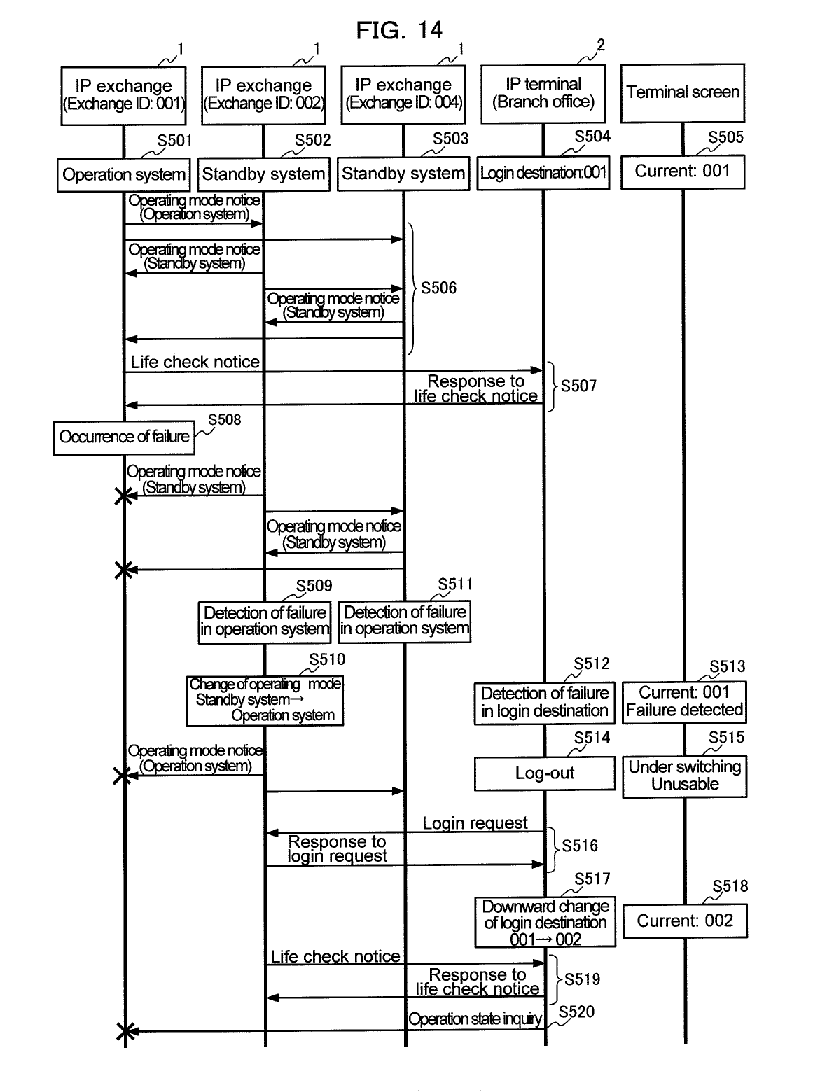

FIG. 14 is a sequence diagram showing the case where a failure has occurred in the IP exchange 1 of the exchange ID “001” in the example shown in FIG. 13, and, as a result, the login destination of the IP terminal 2 placed in the branch office is changed from the IP exchange 1 of the exchange ID “001” to the IP exchange 1 of the exchange ID “002”.

It is assumed that the IP exchange 1 of the exchange ID “001” is operating in “operation system” (S501), the IP exchange 1 of the exchange ID “002” is operating in “standby system” (S502), the IP exchange 1 of the exchange ID “004” is operating in “standby system” (S503), and the login destination of the IP terminal 2 placed in the branch office is the IP exchange 1 of the exchange ID “001” (S504).

In this case, the IP terminal 2 (in the branch office) displays a message on the terminal screen (the operation panel part 22) to indicate that it has logged in to the IP exchange 1 of the exchange ID “001” (S505).

Further, the IP exchange 1 of the exchange ID “001” periodically sends an operating mode notice, which describes the operating mode “operation system” of the IP exchange 1 of the exchange ID “001”, to each of the IP exchange 1 of the exchange ID “002”, the IP exchange 1 of the exchange ID “003” (not shown) and the IP exchange 1 of the exchange ID “004”. Further, the IP exchange 1 of the exchange ID “002” periodically sends an operating mode notice, which describes the operating mode “standby system” of the IP exchange 1 of the exchange ID “002”, to each of the IP exchange 1 of the exchange ID “001”, the IP exchange 1 of the exchange ID “003” (not shown) and the IP exchange 1 of the exchange ID “004”. Further, the IP exchange 1 of the exchange ID “004” periodically sends an operating mode notice, which describes the operating mode “standby system” of the IP exchange 1 of the exchange ID “004”, to each of the IP exchange 1 of the exchange ID “001” and the IP exchange 1 of the exchange ID “002” (S506).

Further, the IP exchange 1 of the exchange ID “001” performs the life check processing on the IP terminal 2 (in the branch office) that has logged in to the IP exchange 1 of the exchange ID “001”, by periodically sending a life check notice to the IP terminal 2 (in the branch office) and by confirming a response to the life check notice from the IP terminal 2 (in the branch office) (S507).

Now, it is assumed that a failure has occurred in the IP exchange 1 of the exchange ID “001” and the operation of the IP exchange 1 of the exchange ID “001” is suspended (S508). As a result, sending of an operating mode notice by the IP exchange 1 of the exchange ID “001” is suspended, and the IP exchange 1 of the exchange ID “002” detects the failure in the IP exchange 1 (of the exchange ID “001”) having the operating mode “operation system” (S509). Then, the IP exchange 1 of the exchange ID “002” switches the operating mode of the IP exchange 1 of the exchange ID “002” from “standby system” to “operation system” (S510).

On the other hand, the IP exchange 1 of the exchange ID “004” also detects the failure in the IP exchange 1 (of the exchange ID “001”) having the operating mode “operation system” (S511). However, for the IP exchange 1 of the exchange ID “004”, there is the operating IP exchange 1 (of the exchange ID “002”) that has the priority higher than the priority of the IP exchange 1 of the exchange ID “004” itself, and accordingly, the IP exchange 1 of the exchange ID “004” does not switch the operating mode of the IP exchange 1 of the exchange ID “004”. Thus, the operating mode of the IP exchange 1 of the exchange ID “004” remains “standby system”.

Further, sending of a life check notice by the IP exchange 1 of the exchange ID “001” is suspended, and the IP terminal 2 (in the branch office) detects the failure in the IP exchange 1 (of the exchange ID “001”) as the login destination (S512). Then, the IP terminal 2 displays a message on the terminal screen (the operation panel part 2) to indicate that a failure has occurred in the IP exchange as the login destination (S513).

Next, the IP terminal 2 logs out from the IP exchange 1 (of the exchange ID “001”) as the login destination (S514), and logs in to the IP exchange 1 of the exchange ID “002” having the priority one rank lower than the priority of the IP exchange 1 (of the exchange ID “001”) (S516). As a result, the login destination of the IP terminal 2 (in the branch office) is changed from the IP exchange 1 of the exchange ID “001” to the IP exchange 1 of the exchange ID “002” (S517).

Here, between the log-out from the IP exchange 1 of the exchange ID “001” and the login to the IP exchange 1 of the exchange ID “002”, the IP terminal 2 (in the branch office) displays a message on its terminal screen (the operation panel part 22) to the effect that the IP telephone service can not be provided (S515). Then, when the IP terminal 2 (in the branch office) logins to the IP exchange 1 of the exchange ID “002”, the IP terminal 2 displays a message to indicate that the IP terminal 2 (in the branch office) has logged in to the IP exchange 1 of the exchange ID “002” (S518).

Thereafter, the IP exchange 1 of the exchange ID “002” performs the life check processing on the IP terminal 2 (in the branch office) that has logged in to the IP exchange 1 of the exchange ID “002”, by periodically sending a life check notice to the IP terminal 2 (in the branch office) and by confirming a response from that IP terminal 2 (in the branch office) to the life check notice (S519).

Further, the IP terminal 2 (in the branch office) examines whether the IP exchange 1 of the exchange ID “001” is released, by periodically sending an operation state inquiry to the IP exchange 1 of the exchange ID “001” and by confirming a response to the operation state inquiry (S520).

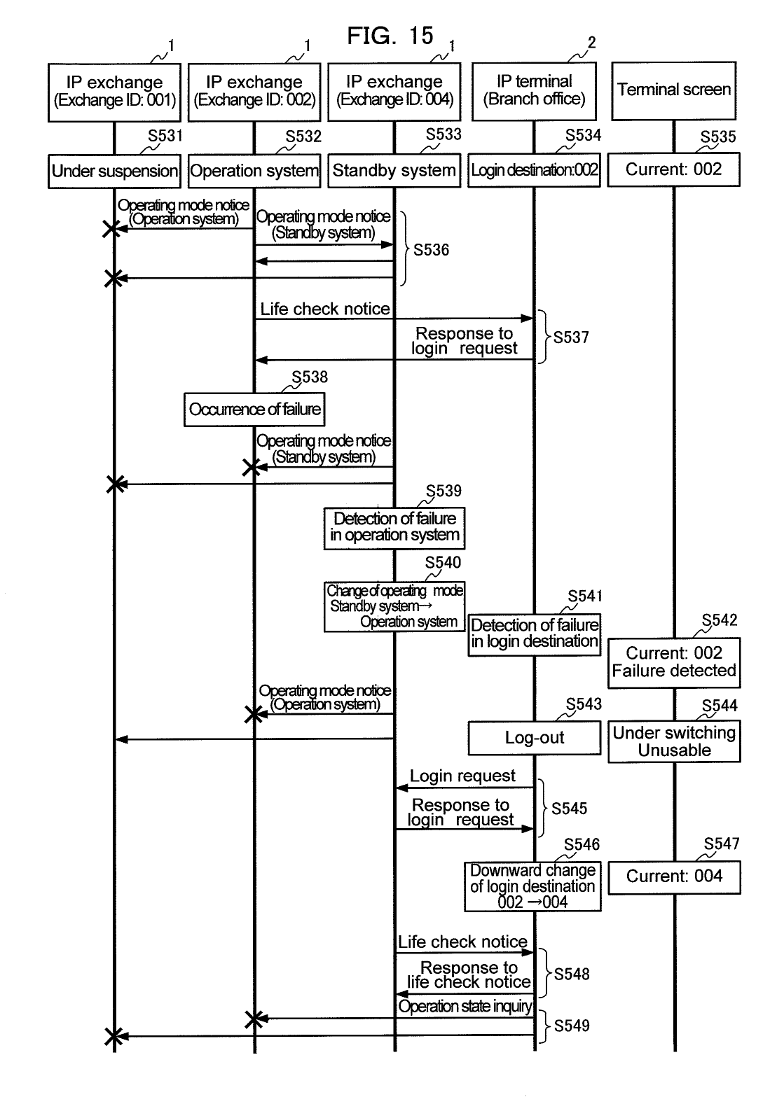

FIG. 15 is a sequence diagram showing the case where a failure has occurred in the IP exchange 1 of the exchange ID “002” while the IP exchange 1 of the exchange ID “001” is suspended in the example shown in FIG. 13, as a result the login destination of the IP terminal 2 placed in the branch office is changed from the IP exchange 1 of the exchange ID “002” to the IP exchange 1 of the exchange ID “004”.

It is assumed that the IP exchange 1 of the exchange ID “001” is “under suspension” (S531), the IP exchange 1 of the exchange ID “002” is operating in “operation system” (S532), the IP exchange 1 of the exchange ID “004” is operating in “standby system”, and the login destination of the IP terminal 2 placed in the branch office is the IP exchange 1 of the exchange ID “002” (S534).

In this case, the IP terminal 2 (in the branch office) displays a message on the terminal screen (the operation panel part 22) to indicate that the IP terminal 2 (in the branch office) has logged in to the IP exchange 1 of the exchange ID “002” (S535).

Further, the IP exchange 1 of the exchange ID “002” periodically sends an operating mode notice, which describes the operating mode “operation system” of the IP exchange 1 of the exchange ID “002”, to each of the IP exchange 1 of the exchange ID “001”, the IP exchange 1 of the exchange ID “003” (not shown) and the IP exchange 1 of the exchange ID “004”. Further, the IP exchange 1 of the exchange ID “004” periodically sends an operating mode notice, which describes the operating mode “standby system” of the IP exchange 1 of the exchange ID “004”, to each of the IP exchange 1 of the exchange ID “001” and the IP exchange 1 of the exchange ID “002” (S536). However, the IP exchange 1 of the exchange ID “001” is under suspension, and does not receive these operating mode notices.

Further, the IP exchange 1 of the exchange ID “002” performs the life check processing on the IP terminal 2 (in the branch office) that has logged in to the IP exchange 1 of the exchange ID “002”, by periodically sending a life check notice to the IP terminal 2 (in the branch office) and by confirming a response to the life check notice from the IP terminal 2 (in the branch office) (S537).

Now, it is assumed that a failure has occurred in the IP exchange 1 of the exchange ID “002” and the operation of the IP exchange 1 of the exchange ID “002” is suspended (S538). As a result, sending of an operating mode notice by the IP exchange 1 of the exchange ID “002” is suspended, and the IP exchange 1 of the exchange ID “004” detects the failure in the IP exchange 1 (of the exchange ID “002”) having the operating mode “operation system” (S539). Then, the IP exchange 1 of the exchange ID “004” switches the operating mode of the IP exchange 1 of the exchange ID “004” from “standby system” to “operation system” (S540).

Further, sending of a life check notice by the IP exchange 1 of the exchange ID “002” is suspended, and the IP terminal 2 (in the branch office) detects the failure in the IP exchange 1 (of the exchange ID “002”) as the login destination (S541). Then, the IP terminal 2 (branch office) displays a message on the terminal screen (the operation panel part 22) to indicate that a failure has occurred in the IP exchange as the login destination (S542).

Next, the IP terminal 2 (in the branch office) logs out from the IP exchange 1 (of the exchange ID “002”) as the login destination (S543), and logs in to the IP exchange 1 of the exchange ID “004” having the priority one rank lower than the priority of the IP exchange 1 (of the exchange ID “002”) (S545). As a result, the login destination of the IP terminal 2 (in the branch office) is changed from the IP exchange 1 of the exchange ID “002” to the IP exchange 1 of the exchange ID “004” (S546).

Here, between the log-out from the IP exchange 1 of the exchange ID “002” and login to the IP exchange 1 of the exchange ID “004”, the IP terminal 2 (in the branch office) displays a message on the terminal screen (the operation panel part 22) to the effect that the IP telephone service can not be provided (S544). Then, when the IP terminal 2 (in the branch office) logins to the IP exchange 1 of the exchange ID “004”, the IP terminal 2 (in the branch office) displays a message on the terminal screen (the operation panel part 22) that the IP terminal 2 (in the branch office) has logged in to the IP exchange 1 of the exchange ID “004” (S547).

Thereafter, the IP exchange 1 of the exchange ID “004” performs the life check processing on the IP terminal 2 (in the branch office) that has logged in to the IP exchange 1 of the exchange ID “004”, by periodically sending a life check notice to the IP terminal (in the branch office) and by confirming a response from the IP terminal 2 (in the branch office) to the life check notice (S548).

Further, the IP terminal 2 (in the branch office) examines whether the IP exchange 1 of the exchange ID “001” and the IP exchange 1 of the exchange ID “002” are released or not, by periodically sending operation state inquiries to the IP exchange 1 of the exchange ID “001” and the IP exchange 1 of the exchange ID “002” and by confirming their responses to the operation state inquiries respectively (S549).

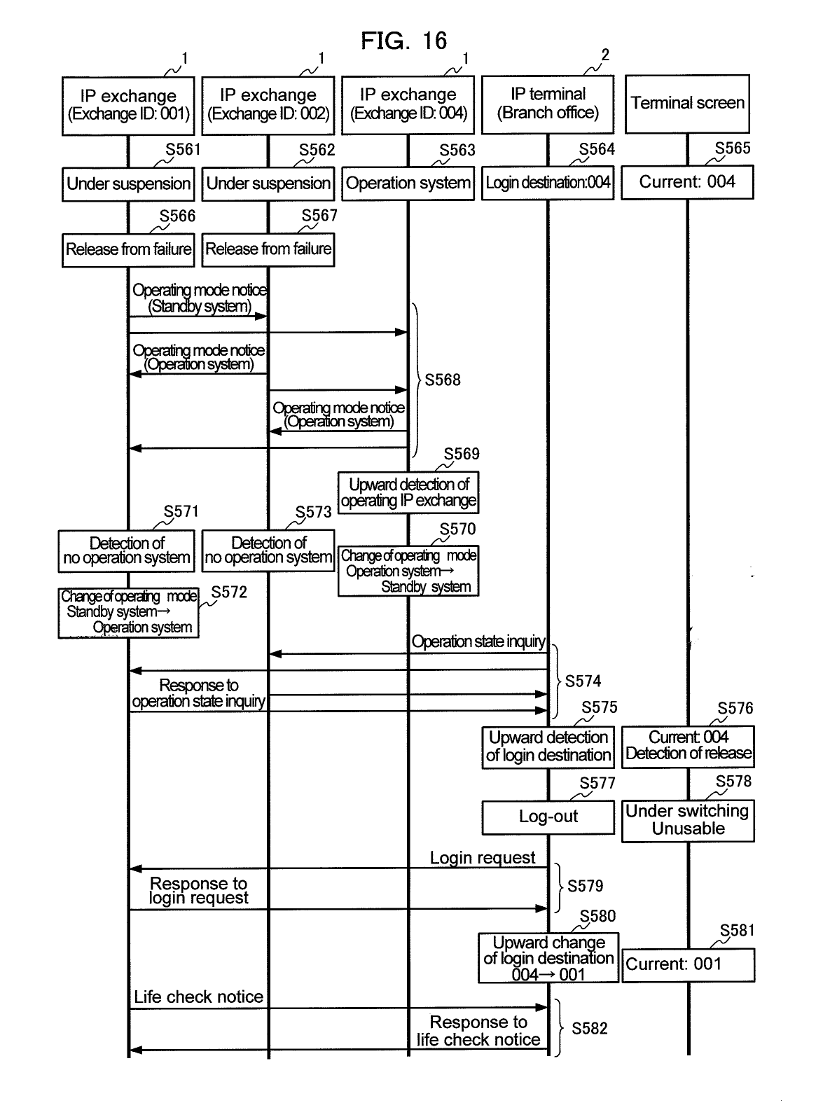

FIG. 16 is a sequence diagram showing the case where the IP exchange 1 of the exchange ID “001” and the IP exchange 1 of the exchange ID “002” in the example shown in FIG. 13 are released from their failures, and as a result the login destination of the IP terminal 2 placed in the branch office is changed from the IP exchange 1 of the exchange ID “004” to the IP exchange 1 of the exchange ID “001”.

It is assumed that the IP exchange 1 of the exchange ID “001” is under “suspension” (S561), the IP exchange 1 of the exchange ID “002” is under “suspension” (S562), the IP exchange 1 of the exchange ID “004” is operating in “operation system” (S563), and the login destination of the IP terminal 2 (in the branch office) is the IP exchange 1 of the exchange ID “004” (S564).

In this case, the IP terminal 2 (in the branch office) displays a message on the terminal screen (the operation panel part 22) to indicate that the IP terminal 2 (in the branch office) has logged in to the IP exchange 1 of the exchange ID “004” (S565).

Here, it is assumed that the IP exchange 1 of the exchange ID “001” and the IP exchange 1 of the exchange ID “002” are released from their failures and resume their operations in “standby system” respectively (S566, S567). The IP exchange 1 of the exchange ID “004” is periodically sending an operating mode notice, which describes the operating mode “operation system” of the IP exchange 1 of the exchange ID “004”, to the IP exchange 1 of the exchange ID “001” and the IP exchange 1 of the exchange ID “002”. In addition to this, also the IP exchange 1 of the exchange ID “001” starts periodical sending of an operating mode notice, which describes the operating mode “standby system” of the IP exchange 1 of the exchange ID “001”, to each of the IP exchange 1 of the exchange ID “002”, the IP exchange 1 of the exchange ID “003” (not shown) and the IP exchange 1 of the exchange ID “004”. Similarly, also the IP exchange 1 of the exchange ID “002” starts periodical sending of an operating mode notice, which describes the operating mode “standby system” of the IP exchange 1 of the exchange ID “002”, to each of the IP exchange 1 of the exchange ID “001”, the IP exchange 1 of the exchange ID “003” (not shown) and the IP exchange 1 of the exchange ID “004” (S568).

As a result, the IP exchange 1 of the exchange ID “004” detects the operations of the IP exchange 1 of the exchange ID “001” and the IP exchange 1 of the exchange ID “002” having the respective priorities higher than the priority of the IP exchange 1 of the exchange ID “004” (S569), and changes the operating mode of the IP exchange 1 of the exchange ID “004” from the “operation system” to “standby system” (S570).

Thereafter, the IP exchange 1 of the exchange ID “001” detects that there is no IP exchange 1 operating in “operation system” (S571). Then, the IP exchange 1 of the exchange ID “001” confirms that the IP exchange 1 of the exchange ID “001” has the highest priority among the operating IP exchanges 1, and switches the operating mode of the IP exchange 1 of the exchange ID “001” from “standby system” to “operation system” (S572). Similarly, the IP exchange 1 of the exchange ID “002” detects that there is no IP exchange 1 operating in “operation system” (S573). However, the IP exchange 1 (of the exchange ID “001”) having the priority higher than the priority of the IP exchange 1 of the exchange ID “002” is operating, and accordingly the IP exchange 1 of the exchange ID “002” does not switch the operating mode of the IP exchange 1 of the exchange ID “002”. Thus, the operating mode the IP exchange 1 of the exchange ID “002” remains “standby system”.

As a result, the IP exchange 1 of the exchange ID “001” periodically sends an operating mode notice, which describes the operating mode “operation system” of the IP exchange 1 of the exchange ID “001”, to each of the IP exchange 1 of the exchange ID “002”, the IP exchange 1 of the exchange ID “003” (not shown) and the IP exchange 1 of the exchange ID “004”. Further, the IP exchange 1 of the exchange ID “002” periodically sends an operating mode notice, which describes the operating mode “standby system” of the IP exchange 1 of the exchange ID “002”, to each of the IP exchange 1 of the exchange ID “001”, the IP exchange 1 of the exchange ID “003” (not shown) and the IP exchange 1 of the exchange ID “004”. Further, the IP exchange 1 of the exchange ID “004” periodically sends an operating mode notice, which describes the operating mode “standby system” of the IP exchange 1 of the exchange ID “004”, to each of the IP exchange 1 of the exchange ID “001” and the IP exchange 1 of the exchange ID “002”.

Further, the IP exchange 1 of the exchange ID “001” and the IP exchange 1 of the exchange ID “002” respond to respective operation state inquiries that are sent periodically from the IP terminal 2 (in the branch office) (S574). From these responses, the IP terminal 2 (in the branch office) detects that the IP exchange 1 of the exchange ID “001” and the IP exchange 1 of the exchange ID “002” having the respective priorities higher than the priority of the IP exchange 1 as the login destination (having the exchange ID “004”) have been released (S575). Then, the IP terminal 2 (in the branch office) displays a message on the terminal screen (the operation panel part 22) to indicate that the IP exchanges 1 having the priorities higher than the login destination have been released (S576).

Then, the IP terminal 2 (in the branch office) logs out from the IP exchange 1 as the login destination (having the exchange ID “004”) (S577), and logins to the IP exchange 1 of the exchange ID “001” having the highest priority among the operating login destination candidates (S579). As a result, the login destination of the IP terminal 2 (in the branch office) is changed from the IP exchange 1 of the exchange ID “004” to the IP exchange 1 of the exchange ID “001” (S580).

Here, between the log-out from the IP exchange 1 of the exchange ID “004” and the login to the IP exchange 1 of the exchange ID “001”, the IP terminal 2 (in the branch office) displays a message on the terminal screen (the operation panel part 22) to the effect that the IP telephone service can not be provided (S578). Then, when the IP terminal 2 (in the branch office) logins to the IP exchange 1 of the exchange ID “001”, the IP terminal 2 (in the branch office) displays a message on the terminal screen (the operation panel 22) to indicate that the IP terminal 2 (in the branch office) has logged in to the IP exchange 1 of the exchange ID “001” (S581).

Thereafter, the IP exchange 1 of the exchange ID “001” performs the life check processing on the IP terminal 2 (in the branch office) that has logged in to the IP exchange 1 of the IP exchange 1 of the exchange ID “001”, by periodically sending a life check notice to the IP terminal 2 (in the branch office) and by confirming a response from the IP terminal 2 (in the branch office) to the life check notice (S582).

Hereinabove, embodiments of the present invention have been described.

In the embodiments, a plurality of IP exchanges 1 are assigned respective priorities. Each IP exchange 1 autonomously switches its operating mode such that the IP exchange 1 having the highest priority among the operating IP exchanges 1 operates in the operation system, and the other IP exchanges 1 operate in the standby system. As a result, even in the case where three or more IP exchanges 1 are multiplexed each other, the operating mode of each IP exchange 1 can be switched suitably.

Further, in these embodiments, an IP terminal 2 logins to the IP exchange 1 having the highest priority among the operating IP exchanges 1, and receives the IP telephone service from that IP exchange 1. Thus, the login destination of the IP terminal 2 can be changed to follow switching of the operating modes of the IP exchanges 1.

Further, in these embodiments, an IP exchange 1 previously registers information on other IP exchanges as the managed objects, and controls the operating mode of the IP exchange 1 on the basis of the respective operation states and priorities of the managed objects. Further, an IP terminal 2 previously registers information on the IP exchanges as the login destination candidates, and controls the login destination of the IP terminal 2 on the basis of the respective operation states and priorities of the login destination candidates. This makes it possible to construct a flexible backup system in which: for example, IP exchanges 1 of the respective priorities up to the n-th priority (n: a natural number) (one IP exchange 1 for each priority) are arranged for the entire system; IP exchanges 1 of the respective priorities starting with (n+1)-th priority (one IP exchange 1 for each priority) are placed in each base location; the IP exchanges 1 of the priorities up to the n-th priority are made to provide the IP telephone service for all the IP terminal 2; and the IP exchanges 1 of the priorities starting with (n+1)-th priority are made to provide the IP telephone service for the IP terminal 2 placed in the same base location (See FIG. 13).

Further, in the embodiments, an IP terminal 2 displays, on its terminal screen, information on the IP exchange as the login destination, a failure in the IP exchange 1 as the login destination, a non-usable state of IP telephone exchange service at the time of a change of the login destination, and the like. Thus, user-friendliness is improved.

The present invention is not limited to the above embodiments, and can be changed variously within the scope and gist of the invention. For example, the configuration of each of the IP exchanges 1 and the IP terminals 2 can be implemented by hardware using a logic IC such as an Application Specific Integrated Circuit (ASIC) or a Field Programmable Gate Array (FPGA), or by software using a Digital Signal Processor (DSP) or a Personal Computer (PC).

The present invention is suitable for the case where: as in the case of a large business entity such as a big bank for example, a head office or head store exists; branch offices or branch stores are located in various places; an IP terminal is placed in each office or store to carry out business activities; all the IP terminals placed in the head office or head store and in the various places are accommodated by IP exchanges multiplexed through lines (network) such as a Wide Area Network (WAN); and each IP exchange manages connection between IP terminals 2 by controlling call of the IP terminals 2.

Having described the preferred embodiments of the present invention with reference to the accompanying drawings, it is to be understood that the invention is not limited to the embodiments and that various changes and modifications could be effected therein by one skilled in the art without departing from the spirit or scope of the present invention as defined in the appended claims.

What is claimed is:

1. An IP telephone system comprising: a plurality of IP exchanges connected with one another through an IP network, each of which operates in an operation system or a standby system; and at least one IP terminal that logins to one of the IP exchanges to receive an IP telephone exchange service from that IP exchange, wherein:
each of the plurality of IP exchanges comprises:
an operating mode notifying means, which notifies an operating mode of the IP exchange to other IP exchange;
an operation state judgment means, which judges an operation state of the other IP exchange on a basis of sending or non-sending of an operating mode notice from the other IP exchange;
an operation system switching means, which switches the operating mode of the IP exchange from the standby system to the operation system when the operating mode of the IP exchange is the standby system in a case where none of the other IP exchange is judged to be operating in the operation system by the operation state judgment means and priority of the other IP exchange judged to be operating in the standby system by the operation state judgment means is lower than a priority of the IP exchange; and
a standby system switching means, which switches the operating mode of the IP exchange from the operation system to the standby system when the operating mode of the IP exchange is the operation system in a case where there is an IP exchange having a priority higher than the priority of the IP exchange among the other IP exchange judged to be operating in the standby system by the operation state judgment means.

2. An IP telephone system of claim 1, wherein:
each of the plurality of IP exchanges further comprises an inquiry response means, which respond to an operation state inquiry sent from the IP terminal; and
the IP terminal comprises:
a login destination candidate storage means, which stores an address information of each of the other IP exchange as candidates for a login destination, together with the other priority given to the other IP exchange;
an inquiry sending means, which sends an operation state inquiry to a login destination candidate having a priority higher than the priority of the IP exchange to which the IP terminal has logged in; and
a login means, which logs out from the IP exchange to which the IP terminal has logged in and logins to the other IP exchange having a highest priority among the login destination candidate that has sent response to the operation state inquiry, when the response is received; and logs out from the IP exchange to which the IP terminal has logged in and logins to the other IP exchange whose information is stored in the login destination candidate storage means and has a priority one rank lower than the priority of the IP exchange from which the log-out is carried out, when a failure occurs in the other IP exchange to which the IP terminal has logged in.

3. An IP telephone system of claim 2, wherein:
the IP terminal further comprises a display means, which displays information on the IP exchange to which the IP terminal has logged in, as well as a message to an effect that the IP telephone exchange service can not be provided during log-out.

4. An IP telephone system of claim 3, wherein:
the display means displays a message to an effect that the failure has occurred in the IP exchange to which the IP terminal has logged in, when the failure has occurred in the IP exchange.

5. An IP telephone system of claim 1, wherein:
each of the plurality of IP exchanges further comprises a managed object storage means, which stores an address information and the priority for each of the other IP exchange as an object of management of the operation state; and
the operation state judgment means judges the operation state of the other IP exchange whose address information is stored in the managed object storage means, on a basis of sending or non-sending of the operating mode notice from the other IP exchange.

6. An IP telephone system of claim 2, wherein:
each of the plurality of IP exchanges further comprises a managed object storage means, which stores the address information and the priority for each of the other IP exchange as an object of management of the operation state; and
the operation state judgment means judges the operation state of the other IP exchange whose address information is stored in the managed object storage means, on a basis of sending or non-sending of the operating mode notice from the other IP exchange.

7. An IP telephone system of claim 3, wherein:
each of the plurality of IP exchanges further comprises a managed object storage means, which stores the address information and the priority for each of other IP exchange as an object of management of the operation state; and
the operation state judgment means judges the operation state of the other IP exchange whose address information is stored in the managed object storage means, on a basis of sending or non-sending of the operating mode notice from the other IP exchange.

8. An IP telephone system of claim 4, wherein:
each of the plurality of IP exchanges further comprises a managed object storage means, which stores the address information and the priority for each of other IP exchange as an object of management of the operation state; and
the operation state judgment means judges the operation state of the other IP exchange whose address information is stored in the managed object storage means, on a basis of sending or non-sending of the operating mode notice from the other IP exchange.

9. An IP exchange that operates in an operation system or a standby system, comprising:
an operating mode notifying means, which notifies an operating mode of the IP exchange to other IP exchange;
an operation state judgment means, which judges an operation state of the other IP exchange on a basis of sending or non-sending of operating mode notice from the other IP exchange;
an operation system switching means, which switches the operating mode of the IP exchange from the standby system to the operation system when the operating mode of the IP exchange is the standby system in a case where none of the other IP exchanges is judged to be operating in the operation system by the operation state judgment means and priority of the other IP exchange judged to be operating in the standby system by the operation state judgment means is lower than a priority of the IP exchange; and
a standby system switching means, which switches the operating mode of the IP exchange from the operation system to the standby system when the operating mode of the IP exchange is the operation system in a case where there is an IP exchange having a priority higher than the priority of the IP exchange among the other IP exchange judged to be operating in the standby system by the operation state judgment means.

10. An IP terminal that receives an IP telephone exchange service by logging in to an IP exchange of IP exchanges, comprising:
a login destination candidate storage means, which stores address information of each of the IP exchanges as candidates for a login destination, together with a priority given to the IP exchange;
an inquiry sending means, which sends an operation state inquiry to a login destination candidate having a priority higher than the IP exchange to which the IP terminal has logged in; and
a login means, which logs out from the IP exchange to which the IP terminal has logged in and logins to other IP exchange having a highest priority among the login destination candidates that have sent response to operation state inquiries, when the response is received; and logs out from the IP exchange to which the IP terminal has logged in and logins to other IP exchange that is stored in the login destination candidate storage means and has a priority one rank lower than a priority of the IP exchange from which the log-out is carried out, when a failure occurs in the IP exchange to which the IP terminal has logged in.

11. An IP terminal connected to a plurality of IP exchanges connected with one another through an IP network, each of which operates in an operation system or a standby system, the IP terminal logging in to one of the IP exchanges to receive an IP telephone exchange service from that IP exchange, wherein:
the IP terminal comprises:
an inquiry sending means, which sends an operation state inquiry to an IP exchange to as a login destination;
a display means, which displays a state of the IP network on a basis of receiving or non-receiving of a response to the operation state inquiry; and
a login means, which logins to other IP exchange when the response is not received from the IP exchange as the login destination.

12. An IP exchange backup method for backing up an IP exchange operating in an operation system or a standby system, wherein:
each of a plurality of IP exchanges connected with one another through an IP network:
notifies an operating mode of an IP exchange to other IP exchange, and judges an operation state of the other IP exchange on a basis of sending or non-sending of an operating mode notice from the other IP exchange;
switches the operating mode of the IP exchange from the standby system to the operation system when the operating mode is the standby system in a case where none of the other IP exchange is judged to be operating in the operation system and priority of the other IP exchanges judged to be operating in the standby system are lower than a priority of the IP exchange; and
switches the operating mode of the IP exchange itself from the operation system to the standby system when the operating mode is the operation system in a case where there is an IP exchange having a priority higher than the priority of the IP exchange itself among other IP exchanges judged to be operating in the standby system.

13. A login method for an IP terminal to receive an IP telephone service by logging in to one of a plurality of IP exchanges, wherein:
the IP terminal:
sends an operation state inquiry to a login destination candidate having a priority higher than a priority of an IP exchange to which the IP terminal has logged in;
logs out from the IP exchange to which the IP terminal has logged in, and logins to other IP exchange having a highest priority among login destination candidates that have sent responses to operation state inquiries, when the responses are received; and
logs out from the IP exchange to which the IP terminal has logged in, and logins to other IP exchange as a login candidate having a priority one rank lower than the priority of the IP exchange from which the log-out is carried out, when a failure occurs in the IP exchange to which the IP terminal has logged in.
